(19) United States
(12) Patent Application Publication
(10) Pub. No.: US 2019/0184961 A1
(43) Pub. Date: Jun. 20, 2019

(54) METHOD FOR OPERATING A DRIVE TRAIN OF A MOTOR VEHICLE

(71) Applicant: ZF Friedrichshafen AG, Friedrichshafen (DE)

(72) Inventor: Michael GIERLING, Langenargen (DE)

(21) Appl. No.: 16/218,527

(22) Filed: Dec. 13, 2018

(30) Foreign Application Priority Data
Dec. 15, 2017 (DE) 10 2017 222 929.2

(51) Int. Cl. B60W 10/06; B60W 10/184; B60W 30/18; B60W 10/08; B60W 30/14

(52) U.S. Cl. CPC B60W 10/06; B60W 10/184; B60W 30/18072; B60W 2710/182; B60W 30/143; B60W 30/18109; B60W 10/08

(57) ABSTRACT

A method for operating a drive-train (1) of a motor vehicle, wherein the drive-train (1) comprises an internal combustion engine, a transmission connected between the internal combustion engine and a drive output, and a compressed aft system of a brake unit. While the motor vehicle is traveling, if a manual command is issued or if defined operating conditions are satisfied, the drive-train (1) is operated in a coasting mode in which the drive-train (1) is disengaged and the internal combustion engine is turned off. In order to achieve the coasting mode, a pressure in the compressed air system of the brake unit is increased before the internal combustion engine is turned off.

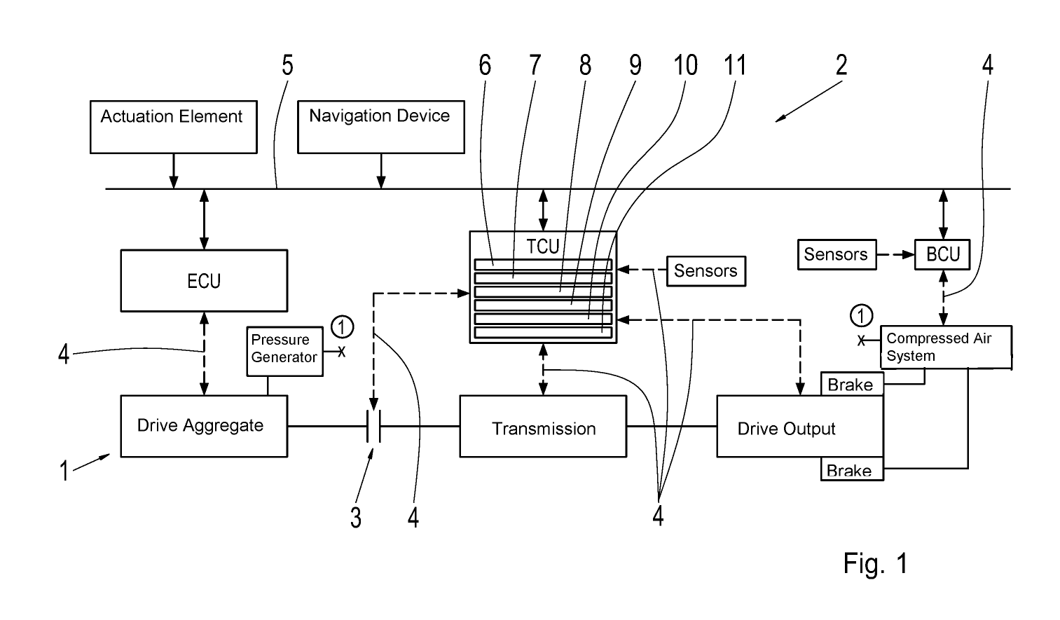

This application claims priority from German patent application serial no. 10 2017 222 929.2 filed Dec. 15, 2017.

### FIELD OF THE INVENTION

The invention relates to a method for operating a drive-train of a motor vehicle. The invention also relates to a control unit for carrying out the method, and to a corresponding computer program product.

### BACKGROUND OF THE INVENTION

In general, it is an aspiration of the development of new motor vehicles and the further development of existing motor vehicles, in particular commercial vehicles, to reduce fuel consumption and the emissions of harmful substances and CO₂. Besides the technical optimization of motor vehicles, such as the development of low-consumption and low-emission drive motors, efficiency-optimized multi-stage manual transmissions, tires with low rolling resistance, and streamlined vehicle bodies, truck drivers' cabins and truck bodies, a further possibility for reducing fuel consumption and the emissions of harmful substances and CO₂ is to use the motor vehicle with appropriate control of the driving operation.

To save energy and costs and to reduce the burden on the environment, in suitable driving situations vehicles can temporarily continue moving ahead without drive-power, in so-termed rolling or coasting mode. In particular, in a motor vehicle in the rolling mode the internal combustion engine can be operated with as low fuel consumption and emissions as possible by idling, while the vehicle is rolling with its drive-train disengaged. If the internal combustion engine is switched off in such a driving situation in order to increase the saving effect still more, the vehicle moves in a so-termed coasting mode. These functions are already known.

Depending on the drive-train components present and the existing type of transmission, the power flow can be interrupted by shifting the transmission to neutral or by opening a starting clutch, as soon as a rolling mode or coasting mode is deemed possible.

It is known that motor vehicles can be equipped with a compressed air system with which various pneumatic components of the motor vehicle can be operated. Particularly in the case of commercial vehicles, for example, a compressed air system can be used to actuate a compressed-air brake unit of the commercial vehicle. To supply the compressed air system with compressed air, the vehicle has an air compressor which is usually permanently in driving connection with a combustion engine of the motor vehicle.

WO 2016/007071 A1 describes a method for controlling an internal combustion engine of a motor vehicle. With regard to a future speed profile, it is established by simulation whether the motor vehicle can be operated in a coasting mode. Before the motor vehicle is operated in the coasting mode, various conditions are checked, which must be satisfied in order to authorize the internal combustion engine to be switched off. One of these conditions is a pressure for a service brake of the motor vehicle, such that if the pressure falls below a specified value switching off of the internal combustion engine is prevented.

### SUMMARY OF THE INVENTION

The purpose of the present invention is to provide a new type of method for operating a drive-train of a motor vehicle. In addition a control unit designed to carry out the method and a computer program product for carrying out the method are to be indicated.

From the process-technological standpoint this objective is achieved, starting from the characterizing features of the independent claims. A control unit for operating a drive-train of a motor vehicle is also the object of the independent claims. As for a computer program product, reference is also made to the independent claims. Advantageous further developments are the object of the subordinate claims and of the description that follows.

A method for operating a drive-train of a motor vehicle is proposed, wherein the drive-train comprises an internal combustion engine, a drive output, a transmission connected between the internal combustion engine and the drive output, and a compressed air system for a pneumatic brake assembly.

The motor vehicle can be a commercial vehicle such as a truck or a bus.

In this case the transmission is in particular a multi-gear transmission in which a plurality of transmission ratio steps, i.e. fixed gear ratios between two shafts of the transmission, can be engaged by shifting elements, preferably in an automated manner. The shifting elements can be interlocking or frictional shifting elements. Such transmissions are used in motor vehicles, especially commercial vehicles, in order to suitably adapt the rotational speed and torque output characteristic of the drive unit to the driving resistances of the vehicle. By appropriate control of the shifting elements the transmission can be brought to a neutral position, in which the internal combustion engine is disconnected from the drive output.

It is provided that during the driving of the vehicle, if a manual command is issued or if defined operating conditions exist, the drive-train is operated in a coasting mode in which the drive-train is opened and, to produce the coasting mode, the internal combustion engine is switched off.

The manual command for the coasting mode can for example be made by a vehicle driver by manually actuating an appropriate operating element. The operating element can for example be in the form of a key or switch arranged on the instrument panel of the motor vehicle.

Before the motor vehicle is operated automatically in the coasting mode various operating conditions are checked, which have to be satisfied in order to authorize disengaging the drive-train and switching off the internal combustion engine. For example, the operating conditions that must be satisfied for coasting operation include a current travel speed higher than a defined minimum speed, the absence of an acceleration demand, the absence of a deceleration demand, and if necessary also a current road gradient between a permissible maximum downhill inclination and a permissible maximum uphill slope.

For example, there is no acceleration demand if an accelerator pedal is not actuated or there is no engine torque demand from an active cruise control, whereas for example there is no deceleration demand if a brake pedal is not actuated or there is no braking torque demand from an active cruise control.

As a further operating condition for the initiation of the coasting mode, while driving with the drive-train closed a speed variation forecast for a road section ahead when the power flow in the drive-train is interrupted, is determined. For this, in a manner known as such, a road gradient variation or a driving resistance profile for the road section ahead can be determined from elevation data taken from a topographical map. From the road gradient variation or driving resistance profile, and taking into account the current travel speed, the mass of the vehicle, the rolling resistance and the air resistance of the vehicle the speed variation when the power flow is interrupted can be determined and, depending on the speed variation determined, the coasting mode can be authorized or blocked. The topographical map can be stored, for example, in a transmission control unit of the transmission or in a navigation unit of the motor vehicle.

As an operating condition for the authorization of the coasting mode the pressure in a brake unit of the motor vehicle can also be taken into account, in such manner that if the pressure falls below a specified value, switching off of the internal combustion engine in the context of the coasting mode is prevented.

The invention is now based on the technical principle that prior to the internal combustion engine being switched off in order to produce the coasting mode, a pressure in the compressed air system of the brake unit is increased. The pressure in the compressed air system of the brake unit can in this case be increased to a predefined pressure value.

The pneumatic brake unit preferably consists of the service brakes of the motor vehicle, which can for example be in the form of wheel brakes.

The pressure in the compressed air system of the brake unit can be sensed by a pressure sensor. For this, the pressure sensor can be fitted into a compressed-air line or a compressed-air reservoir of the compressed air system.

The pressure-generator can be a compressor or concentrator, for example in the form of a reciprocating piston compressor or a membrane compressor. In commercial vehicles so-termed air pressurizers are used, which work in the manner of a compressor. If the pressure-generator is in permanent drive connection with the internal combustion engine of the motor vehicle, then it is not powered during a coasting mode in which the internal combustion engine is switched off, so no pressure is generated during the coasting mode.

If the pressure-generator is not driven during the coasting mode, the pressure level in the compressed air system of the brake unit can fall to an unacceptably low value, for example due to an existing leak in the system. The internal combustion engine then has to be restarted so that the pressure-generator is activated again and the pressure in the compressed air system of the brake unit increased. Thus the pressure in the compressed air system of the brake unit serves as a criterion for terminating the coasting mode.

If the pressure in the compressed air system of the brake unit has been increased already before the internal combustion engine is switched off, then the drive-train can be operated in the coasting mode for a longer time. Consequently the fuel consumption and the emissions of harmful substances and CO₂ can be further reduced.

In an advantageous further development, it is provided that for a route section ahead of the motor vehicle a time duration is predicted, during which the drive-train can be operated in the coasting mode. Thus, as a function of a route section to be covered by the motor vehicle it is determined for how long the motor vehicle can be operated in the coasting mode.

Depending on the time during which the coasting mode is possible on the route section ahead, a pressure is determined which must be present in the compressed air system of the brake unit in order to be able to operate the drive-train in the coasting mode for the predicted time.

The longer the time during which the drive-train can be operated in the coasting mode, the higher is the pressure needed in the compressed air system of the brake unit in order to be able to maintain the coasting mode throughout that time.

If it is found that the pressure currently present in the compressed air system of the brake unit is too low to maintain the coasting mode for the time determined, then the pressure in the compressed air system of the brake unit is increased to at least the pressure level required for the forthcoming coasting mode before the internal combustion engine is switched off in order to produce the coasting mode.

For the determination of the pressure required for maintaining the coasting mode during the predicted time, at least a system leak in the compressed air system of the brake unit is allowed for. A pressure loss due to the operation of pneumatic consumers present in the drive-train can also be taken into account for determining the pressure.

Thus, before the internal combustion engine is switched off the pressure in the compressed air system of the brake unit is already increased to a pressure level required for the drivetrain to be able to be operated in the coasting mode for the predicted time. In that way interruption of the coasting mode due to too low a pressure in the compressed air system of the brake unit can be prevented. Consequently the fuel consumption and the emissions of harmful substances and CO₂ can be correspondingly reduced.

In an advantageous further development, it is provided that the pressure in the compressed air system is increased to a predefined maximum pressure value higher than the normal operating pressure before the internal combustion engine is switched off. In this case the maximum pressure should be chosen such that the compressed air system sustains no damage. In that way the drive-train can be operated in the coasting mode for a maximum time in relation to the operating condition of the pressure level in the compressed air system of the brake unit, and thereby the fuel consumption and the emissions of harmful substances and CO₂ can be correspondingly reduced.

The predicted time during which the drive-train can be operated in the coasting mode can be determined with reference to an evaluation of data from a navigation system, wherein from a current position of the motor vehicle an expected travel route of the motor vehicle is taken into account.

The invention also relates to a control unit designed to carry out the method according to the invention. The control unit comprises means that serve to implement the method according to the invention. These means include hardware means and software means. The hardware means of the control unit are interfaces for the exchange of data with the assemblies of the drive-train that participate in carrying out the method according to the invention. For this, the control unit is also connected to necessary sensors and if needs be also to other control units in order to pick up the decision-relevant data and to issue control commands. For example the control unit can be in the form of a transmission control unit or a brake control unit. The hardware means of the control unit also include a processor for data processing and if appropriate, a memory for data storage. The software means consist of program modules for carrying out the method according to the invention.

The system according to the invention can also be embodied as a computer program product which, when it is running on a processor of a control unit, instructs the processor software to carry out the associated process steps which are the object of the invention. In this connection the object of the invention also includes a computer-readable medium on which the aforesaid computer program product can be stored and recalled.

The invention is not limited to the combination of features indicated in the independent claims or the claims that depend on them. There are in addition possibilities for combining individual features with one another, provided that they emerge from the claims, the description given below, or directly from the figure.

### BRIEF DESCRIPTION OF THE DRAWINGS

Preferred further developments emerge from the subordinate claims and the following description. An example embodiment of the invention, to which it is not limited is explained in greater detail with reference to the figure. The sole figure shows a schematic representation of a drive-train with a control unit for carrying out the method according to the invention.

### DETAILED DESCRIPTION OF THE PREFERRED EMBODIMENTS

The figure shows a schematic representation of a drive-train 1 of a motor vehicle which is a commercial vehicle such as a truck or a bus. This drive-train 1 comprises a drive aggregate that can be coupled on its drive output side to the drive input side of a transmission by way of an interposed starting clutch 3. On its drive output side the transmission is then connected to other drive output components long known to those familiar with the subject, and to the vehicle wheels of the commercial vehicle.

The drive aggregate of the motor vehicle can be in the form of an internal combustion engine. Besides an internal combustion engine, however, the drive aggregate can also comprise an electric machine and consequently be in the form of a hybrid drive.

The transmission is preferably an automatic or automated transmission in which, to engage gear steps, frictional and/or interlocking shifting elements are closed.

The drive-train 1 can be disengaged either by opening the starting clutch 3 or by shifting the transmission to neutral. When the drive-train 1 is disengaged the internal combustion engine is disconnected from the drive output.

The drive-train 1 is additionally equipped with a compressed air system, of which in this case only a small part is illustrated schematically. The compressed air system comprises a pressure-generator that produces compressed air or pressurized air and makes it available to the compressed air system. In this case the pressure-generator expediently works as a compressor and is here in permanent drive connection with the drive aggregate. The compressed air system also comprises at least one compressed-air reservoir, in which compressed air or pressurized air can be stored. Here, the compressed air system serves to operate a pneumatic brake unit of the drive-train 1.

The brakes of the motor vehicle are in the form of wheel brakes actuated by the compressed air system.

In addition the motor vehicle comprises a control system 2 in which a plurality of different control units are connected to one another by way of a data bus system 5, for example a CAN bus system. Among others, in the data bus system 5 an engine control unit ECU, a transmission control unit TCU and a brake control unit BCU are provided, of which the engine control unit ECU is responsible for controlling the drive aggregate, the transmission control unit TCU for controlling the transmission and—in some circumstances indirectly via a further control unit also the starting clutch 3, and the brake control unit BCU for controlling the pneumatic brake unit. The transmission control unit TCU can communicate bidirectionally on the one hand with the transmission and on the other hand with the engine control unit ECU and the brake control unit BCU. By way of the data bus system 5 the control units are provided with the data relevant for them. The control units can receiving signals from the sensors, process those signals, and as a function of them emit control or data signals.

Thus, for example, the transmission control unit ICU comprises a processor 6 and storage means 7 for the storage and recall of parameters, signals and information, as well as a computer program product 11 designed in such manner that it can bring about operation of the drive-train in a coasting mode, taking into account a pressure in the compressed air system of the brake unit. In addition the transmission control unit TCU comprises at least one receiver interface 8 designed to receive all the relevant data from the sensors present. The transmission control unit TCU also comprises a data processing device 9 for processing and evaluating the data received or the information in the data received, and a transmitting interface 10 via which corresponding signals can be emitted for the actuation of drive-train components.

The transmission control unit TCU controls the operation of the transmission with reference to driving condition data and data reflecting the wishes of the driver. A shifting strategy stored in the transmission control unit ICU in the form of a computer program determines respective shifting reactions, in particular a gearshift from a current actual gear to a target gear, or a temporary power flow interruption in the drive-train 1.

Besides the road condition determined, the driving condition data used can include the current driving resistance, the current vehicle inclination, the current vehicle mass, the current vehicle speed, the current vehicle acceleration, the current engine torque, the current engine rotation speed and other values. These data can at least in part be supplied by the engine control unit ECU and by suitable sensor devices.

Driver's wish data can for example be signaled by the actuation of an actuation element, or detected by sensors, and sent directly or indirectly to the transmission control unit TCU. The actuation element can for example be in the form of an accelerator pedal or a switch for the manual initiation of the coasting mode.

Data from a navigation device are supplied to the control unit 2. The navigation device provides topographical data about the surroundings of a current position of the motor vehicle and about the surroundings at a defined distance ahead of the current position of the motor vehicle. The location of the current vehicle position can be determined by means of a satellite positioning system such as GPS or GLONASS.

The control units are connected for data exchange with data-transmitting connections 4 to corresponding components of the drive-train 1. The data-transmitting connections 4 between the control units and the drive-train components can for example be in the form of one or more electronic bus systems.

The method according to the invention for operating a drive-train 1 of the motor vehicle now provides that before the motor vehicle is operated in the coasting mode, various operating conditions are checked, which must be satisfied in order to authorize the internal combustion engine to be switched off.

If the operating conditions for the coasting mode are satisfied, then before the internal combustion engine is switched off in order to produce the coasting mode the pressure in the compressed air system of the brake unit is increased. When the drive-train 1 is subsequently operated in the coasting mode, then due to the higher pressure level in the compressed air system of the brake unit the coasting mode can be used for a longer time provided that the other operating conditions for the coasting mode are also still satisfied.

The switching off of the internal combustion engine for the purposes of the coasting mode can be initiated or prevented, for example, by the transmission control unit TCU. For this, the TCU sends a corresponding signal to the engine control unit ECU, which thereupon switches off the internal combustion engine. Before the internal combustion engine is switched off to produce the coasting mode, the transmission control unit TCU authorizes an increase of the pressure in the compressed air system of the brake unit, in that the pressure level in the pressure reservoir of the compressed sir system is increase.

Alternatively, the switching off of the internal combustion engine to produce the coasting mode and the increase of pressure in the compressed air system of the brake unit can be carried out by the brake control unit BCU.

### INDEXES

1 Drive-train

2 Control system

3 Starting clutch

4 Connection

5 Data bus system

6 Processor

7 Storage means

8 Receiving interface

9 Data processing device

10 Transmitting interface

11 Computer program product

ECU Engine control unit

TCU Transmission control unit

BCU Brake control unit

1-6. (canceled)

7. A method for operating a drive-train (1) of a motor vehicle having an internal combustion engine, a transmission connected between the internal combustion engine and a drive output, and a compressed air system of a brake unit, the method comprising:
while the motor vehicle is traveling, operating the drive-train (1) in a coasting mode during which the drive-train (1) is disengaged and the internal combustion engine is turned off, if either a manual command is issued or defined operating conditions exist; and
increasing a pressure in the compressed air system of the brake unit, prior to turning off the internal combustion engine in order to produce the coasting mode.

8. The method according to claim 7, further comprising predicting a duration of time during which the drive-train is operable in the coasting mode for a route section ahead,
determining a pressure, which must be present in the compressed air system of the brake unit in order to be able to operate the drive-train in the coasting mode for the predicted duration of time, and
increasing the pressure in the compressed air system of the brake unit, at least to the determined pressure, before the internal combustion engine is turned off for the coasting mode, if a current pressure in the compressed air system of the brake unit is lower than the determined pressure.

9. The method according to claim 7, further comprising increasing the pressure in the compressed air system of the brake unit to a predefined maximum pressure value, above a normal operating pressure, before the internal combustion engine is turned off.

10. The method according to claim 8, further comprising determining, with reference to an evaluation of data from a navigation system, the predicted duration of time during which the drive-train can be operated in the coasting mode.

11. A control unit (BCU, TCU) for operating a drive-train (1) of a motor vehicle for carrying out the method according to claim 7.

12. A computer program product with program code means stored on a computer-readable data carrier for carrying out the method according to claim 7, when the computer program product is either run on a computer or on a computer unit of a control unit (BCU, TCU) of the drive train.
